(19) United States
(12) Patent Application Publication
(10) Pub. No.: US 2026/0288183 A1
(43) Pub. Date: Sep. 24, 2026

(54) VOLTAGE REGULATOR

(71) Applicants: Huanhuan Zhang, Ashland, MA (US); Yura Kocharyan, Fremont, CA (US); Kelly Livingston, Beaverton, OR (US); Arvind Raghavan, Lexington, MA (US); Keng Chen, Acton, MA (US)

(72) Inventors: Huanhuan Zhang, Ashland, MA (US); Yura Kocharyan, Fremont, CA (US); Kelly Livingston, Beaverton, OR (US); Arvind Raghavan, Lexington, MA (US); Keng Chen, Acton, MA (US)

(21) Appl. No.: 19/087,172

(22) Filed: Mar. 21, 2025

(51) Int. Cl. G05F 1/575

(52) U.S. Cl. CPC G05F 1/575

(57) ABSTRACT

An apparatus includes an amplifier with a first differential pair of transistors, a second first differential pair of transistors, and a first resistor. The first differential pair of transistors includes a first pair of source terminals coupled to a voltage supply (Vcc) rail. The second differential pair of transistors includes a second pair of source terminals. The first resistor is coupled between the second pair of source terminals. The apparatus further includes a second resistor coupled to an output of the amplifier. The apparatus further includes a compensator circuit with an output terminal coupled to the second resistor. The compensator circuit is to generate a compensator output voltage signal based on a first reference voltage signal.

### BACKGROUND

For a computer central processing unit (CPU) system with core, memory, input/output (IO), etc., each domain module has its respective voltage converter but shares the same input voltage (Vin) as the input to the local voltage converter. The Vin voltage can vary up to ~200 mV coupled from a particular load transient event, clock feedthrough, etc. However, a considerable Vin peak-to-peak noise can couple to the load domains sharing this Vin, causing the switching regulator's output voltage (Vout) to drop. Such output voltage droop causes deterioration of the CPU system performance.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings listed below.

FIG. 1 is a block diagram of a power delivery system-on-a-chip (SoC), in accordance with some embodiments.

FIG. 2 is a block diagram of a voltage regulator with a feedforward path in a prior art configuration.

FIG. 3 is a block diagram of a voltage regulator with a feedforward path, in accordance with some embodiments.

FIG. 4 is a graph of output current (Iout) versus input voltage (Vccin), in accordance with some embodiments.

FIG. 5 is a graph of output (or load) voltage Vout (or Vload) response to input voltage (Vin) changes, in accordance with some embodiments.

FIG. 6 is a block diagram of a voltage regulator with a feedforward path based on compensator input voltage, in accordance with some embodiments.

FIG. 7 is a block diagram of a voltage regulator with an input voltage feedforward path to a triangle wave generator (TWG), in accordance with some embodiments.

FIG. 8 is a flow diagram of an example process of making a voltage regulator, in accordance with some embodiments.

FIG. 9 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “a processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

As used herein, the term “IO” indicates input/output. As used herein, the term “R-C” indicates resistance and capacitance. As used herein, the term “Rx” indicates receiver (or receive). As used herein, the term “Tx” indicates transmitter (or transmit). As used herein, the term “TRX” indicates transceiver. As used herein, the term “UCIe” indicates Universal Chiplet Interconnect Express. As used herein, the term “Vref” indicates reference voltage. As used herein, the term “Vin” indicates input voltage. As used herein, the terms “serially coupled,” “serially connected,” and “connected in series” are synonymous to each other and indicate a serial connection between two or more components/circuits where the serial connection can be based on a direct or indirect electrical connection between the two or more components/circuits. As used herein, the terms “parallel coupled,” “parallel connected,” and “connected in parallel” are synonymous to each other and indicate a parallel connection between two or more components/circuits where the parallel connection can be based on a direct or indirect electrical connection between the two or more components/circuits.

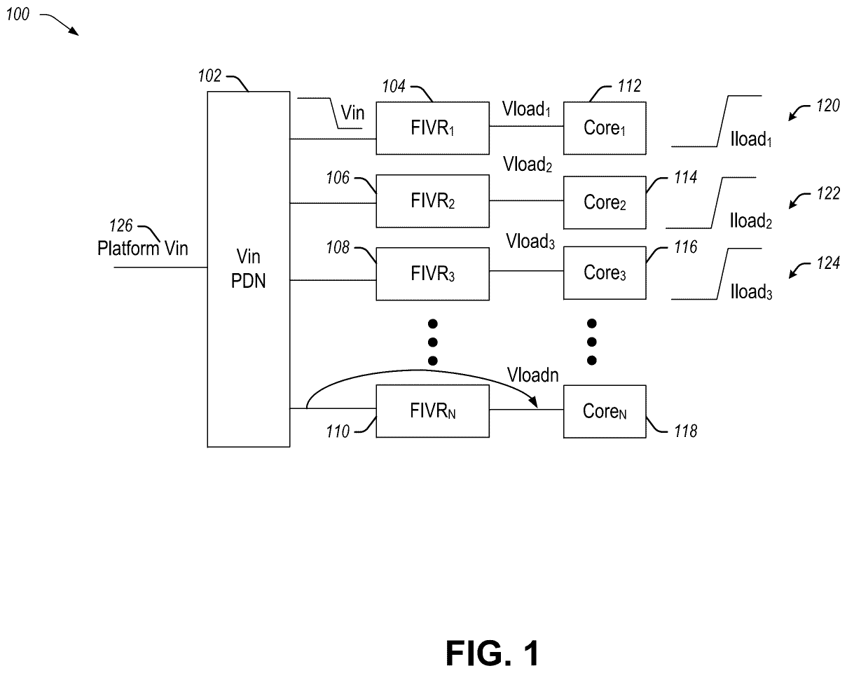

The disclosed techniques (e.g., as discussed in connection with FIGS. 1-9) include using an input voltage (Vin) feedforward path to mitigate (e.g., reduce or cancel) Vin-induced noise, thereby reducing the nominal voltage (Vnominal) to save power.

FIG. 1 is a block diagram of a power delivery system-on-a-chip (SoC) 100, in accordance with some embodiments. Referring to FIG. 1, SoC 100 includes a power distribution network (PDN) 102, voltage regulators (VRs) 104, 106, 108, . . . , 110, and load circuits 112, 114, 116, . . . , 118. PDN 102 receives platform Vin 126 and distributes Vin to VRs 104, . . . , 110. In some aspects, VRs 104, . . . , 110 can be fully integrated voltage regulators (FIVRs). FIG. 1 further illustrates example load current (Iload) graphs 120, 122, and 124 for load circuits 112, 114, and 116, respectively.

In some aspects, load circuits 112, . . . , 118 can include CPU core circuits, memory circuits, input/output (IO) circuits, etc. As illustrated in FIG. 1, each load circuit is coupled to its respective VR, while all load circuits share the same input voltage Vin as the input to the local voltage converter. In some aspects, the Vin voltage can vary up to ~200 mV coupled from a particular load transient event, clock feedthrough, etc. However, a considerable Vin peak-to-peak noise will couple to the load domains sharing this Vin, causing the switching regulator's Vout to drop. As the load domain can be configured to meet the minimum voltage of Vload (which can be referred to as Vmin), the Vload nominal has to be set higher to compensate for the Vin-induced Vload drop.

Suppose the nominal voltage is 2% higher because of Vin noise feedthrough, the domain power is 4% higher as power is proportional to V². With the disclosed techniques, a Vin feedforward path is introduced to cancel Vin-induced noise. Thus, V nominal will be reduced to save power. On the other hand, a power converter (e.g., a FIVR) has parallel current injection paths that trigger when Vload drops under a threshold voltage during a load transient event. The Vin coupled noise will cause this parallel path to frequently refire, introducing extra noise on Vload.

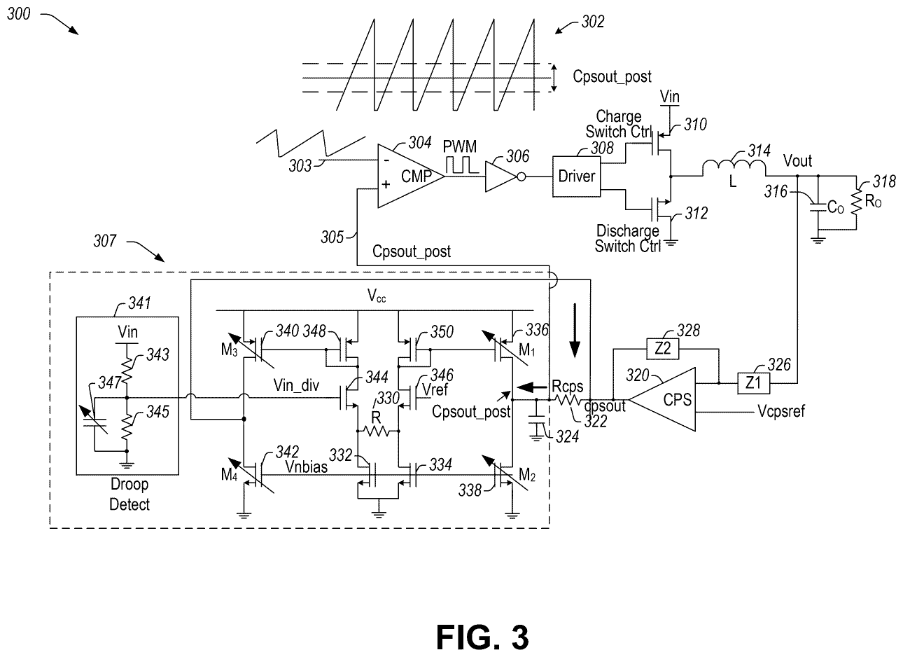

Conventional VR designs lack mitigation of the Vin noise feedthrough. In some aspects, this issue can be mitigated by setting a higher Vload nominal and setting a relaxed threshold standard for the parallel current paths. The proposed techniques (e.g., as discussed in connection with FIG. 3) can be used to mitigate the Vin noise feedthrough.

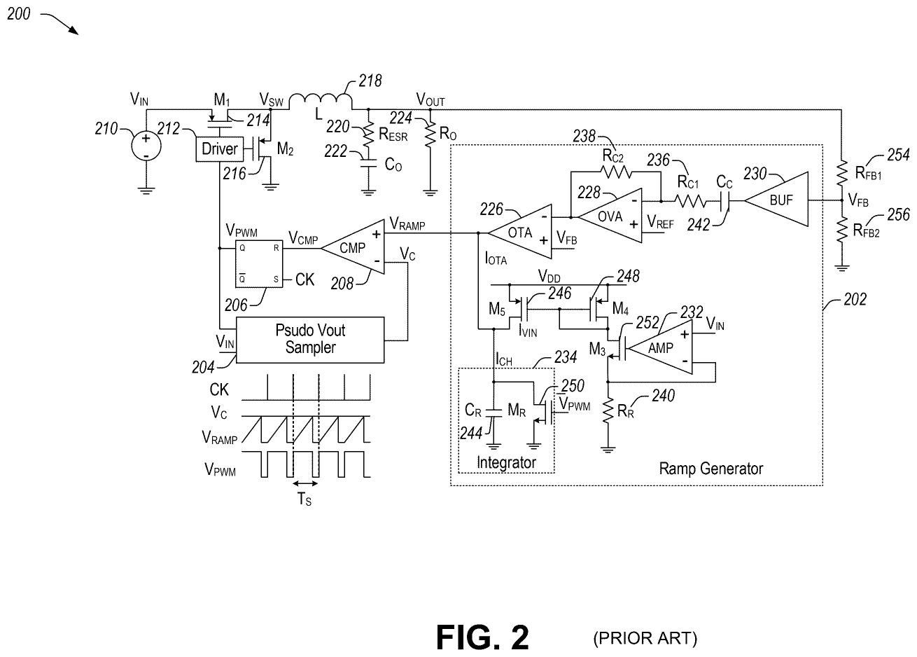

FIG. 2 is a block diagram of a voltage regulator with a feedforward path in a prior art configuration. Referring to FIG. 2, VR 200 includes a voltage source 210, a driver 212, transistors 214 and 216, inductance 218, capacitor 222, and resistors 220, 224, 254, and 256. VR 200 further includes a ramp generator 202, a flip-flop 206, a comparator 208, and a sampler 204.

In some aspects, ramp generator 202 includes an integrator 234, amplifiers 226, 228, and 232, buffer 230, capacitor 242, resistors 236, 238, and 240, and transistors 246, 248, and 252. In some aspects, integrator 234 includes capacitor 244 and transistor 250.

FIG. 2 also illustrates timing diagrams of the clock signal CK and voltage signals Vc, Vramp, and Vpwm.

In VR 200, the Vin feedforward path can be configured so that the integrating current to generate a triangle wave generator (TWG) signal is proportional to Vin. In this regard, Vout will instantaneously change as Vin changes. This technique method, however, may be ineffective for FIVR-based designs as a FIVR is designed for a wide range of switching frequencies (e.g., 20 MHz-200 MHz), unlike the single frequency design illustrated in FIG. 1. In some aspects, a TWG integrating current is a slow path as there is an integrator in the loop, and any high-frequency change on the Vin will be filtered.

FIG. 3 is a block diagram of a voltage regulator with a feedforward path, in accordance with some embodiments. Referring to FIG. 3, VR 300 includes a comparator 304, an inverter 306, a driver 308, switch transistors 310 and 312, inductance 314, capacitor 316, resistor 318, impedance circuits 326 and 328, compensator circuit 320, compensator resistor 322, and amplifier 307.

In some aspects, amplifier 307 is a fully-differential trans-impedance amplifier. In some aspects, amplifier 307 includes transistors 332, 334, 336, 338, 340, 342, 344, 346, 348, and 350. Amplifier 307 also includes a capacitor 324 coupled to a ground terminal and a degenerating resistor 330 coupled between differential pair source terminals (e.g., as illustrated in FIG. 3).

In some aspects, compensator circuit 320 generates voltage signal cpsout, which is converted to compensator output voltage signal 305 (Cpsout_post) after the compensator resistor 322. FIG. 3 also illustrates a timing diagram 302 of the compensator output voltage signal 305.

The compensator output voltage signal 305, along with a TWG signal 303, are communicated as inputs to comparator 304, which generates a pulse-width modulated (PWM) signal as output.

As illustrated in FIG. 3, the disclosed techniques add a Vin feedforward path from Vin to Vout, such that a direct compensation path to Vout is formulated, avoiding the compensator-based main loop, which is slow in settling. As the current for TWG signal generation is a slow circuit, the feedforward path is not added to the TWG. Instead, it is added to the compensation voltage. As illustrated in FIG. 3, a differential current equal to k/R*ΔVin is applied to generate a delta voltage Rcps/R*ΔVin across resistor Rcps (compensator resistor 322) on top of cpsout. This new comparator output voltage 305 (or Cpsout_post) can be used to regulate the power train switches. Cpsout_post reacts to Vin directly, forming the feedforward path. In some aspects, transistors 336-342 (M1-M4) are configurable current mirrors.

In some aspects, the disclosed techniques are used to reduce Vout droop induced by Vin noise. In this regard, Vnominal can be set lower to meet a Vmin specification. In some aspects, load power is reduced accordingly. If Vnominal is reduced by 2%, the load power has 4% savings.

In some aspects, the disclosed techniques are used to reduce parallel current source (PCS) (e.g., a parallel path for current injection of FIVR) refiring frequency, such that the PCS trigger threshold can be set tighter, improving the FIVR's Vout droop performance.

For the FIVR system in FIG. 3,

$${V}_{out} = {V}_{in} * \frac{{V}_{cps}}{V ramp} ,$$

where Vcps is the compensator circuit output voltage, and Vramp is the ripple voltage of the TWG waveform. Vin OTA (e.g., Vin of the amplifier 307 which can be an operational transconductance amplifier, or OTA) generates a current equal to k*gm*Vᵢₙ, where k means a fraction of Vin is sensed by the OTA circuit with a factor k, and gm is the transconductance of the OTA. This current goes across the Rcps resistor and generates a voltage k*gm*Vᵢₙ*R_{cps} that is added to Vcps. In this regard, the Vout equation is modulated to

$${V}_{out} = {V}_{in} * \frac{{V}_{cps} \pm {kg}_{m} {V}_{in} {R}_{cps}}{V ramp} .$$

When Vin drops, a positive voltage is added to Vcps, so Vout stays almost constant and vice versa. A benefit of the disclosed techniques is maintaining Vcps as constant as possible in a Vin transient event.

In some aspects, VR 300 further includes a droop detection circuit 341. In some aspects, the droop detection circuit 341 can be implemented as part of amplifier 307 (as illustrated in FIG. 3) or separately from amplifier 307. In some aspects, droop detection circuit 341 can include a tunable filter configured with resistors 343 and 345 and tunable capacitor 347 (Vcc is usually a quieter voltage rail than Vin, so the Vin droop detection circuit 341 is configured with tunable filtering frequencies).

In some aspects, the compensation current from amplifier 307 is tunable as transistors M1/M2/M3/M4 are tunable. That means the compensation strength is tunable and expected to be <100% to avoid fighting with the main regulation loop.

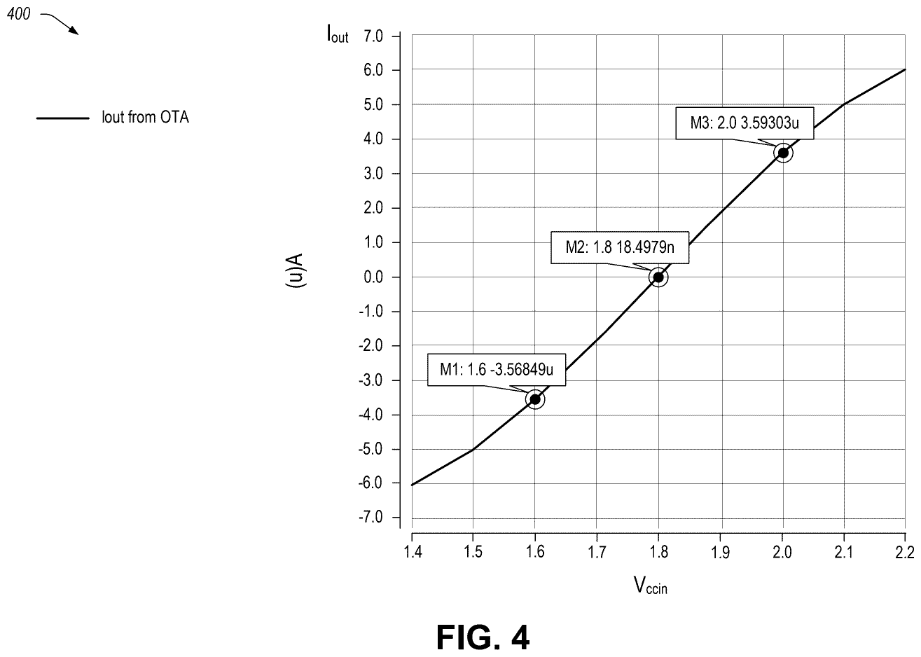

FIG. 4 is a graph 400 of output current (Iout) versus input voltage (Vccin), in accordance with some embodiments. In a resistor degeneration design, a large R-value and a large gm of the input transistor pair are chosen. Iout versus Vin is very linear in a Vin range of 1.5V-2.1V (with 1.8V being the standard voltage for Vin).

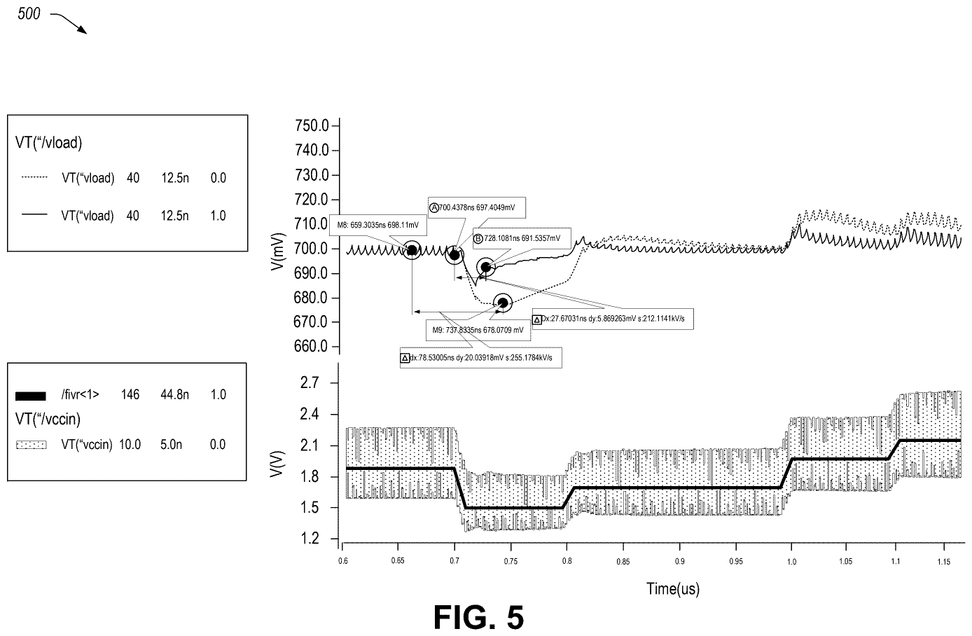

FIG. 5 is graph 500 of output (or load) voltage Vout (or Vload) response to input voltage (Vin) changes, in accordance with some embodiments. Graph 500 can be generated by testing a close-loop FIVR system. Vout is regulated to 700 mV at 80 MHz switching frequency. Vin changes in a step from 1.8V to 1.4V, then to 1.6V, 1.9V, and finally changes to 2.1V. Two Vload waveforms are shown in FIG. 5, with and without the feedforward feature. Graph 500 shows the disclosed techniques improve the droop from 20 mV to ~6 mV at the worst case where Vin changes from 1.8V to 1.4V.

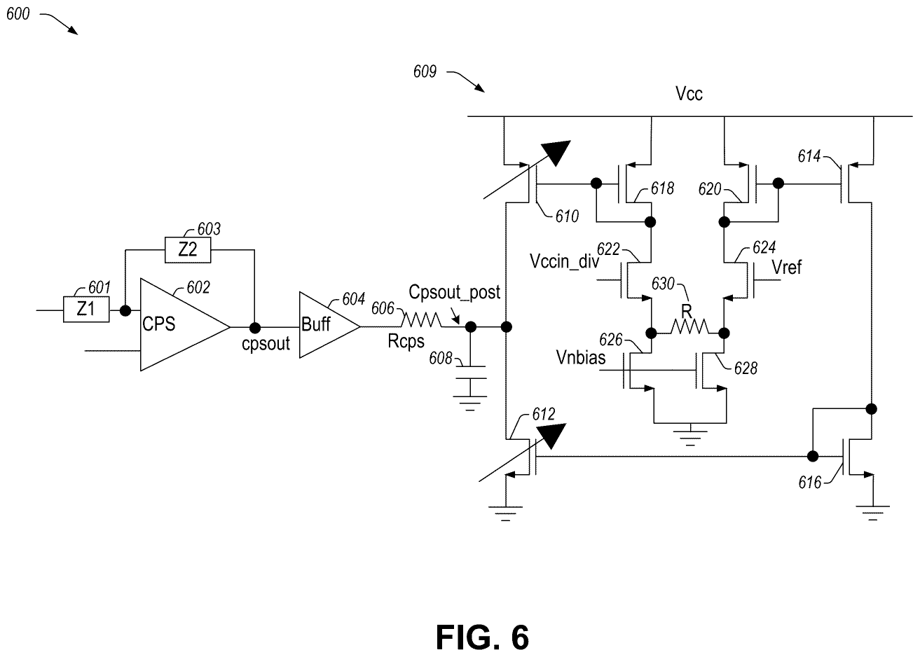

FIG. 6 is a block diagram of a voltage regulator 600 with a feedforward path based on compensator input voltage, in accordance with some embodiments. Referring to FIG. 6, VR 600 includes a compensator circuit 602, impedance circuits 601 and 603, a buffer 604, inductance 606, capacitor 608, and amplifier 609. In some aspects, amplifier 609 includes transistors 610, 612, 614, 616, 618, 620, 622, 624, 626, and 628. Amplifier 609 also includes a degenerating resistor 630 coupled between differential pair source terminals (as illustrated in FIG. 6).

FIG. 6 illustrates another Vin feedforward implementation, where OTA current is injected into the Rcps resistor 606 as a single-ended current. In some aspects, a buffer can be added to avoid introducing systematic offset on the amplifier.

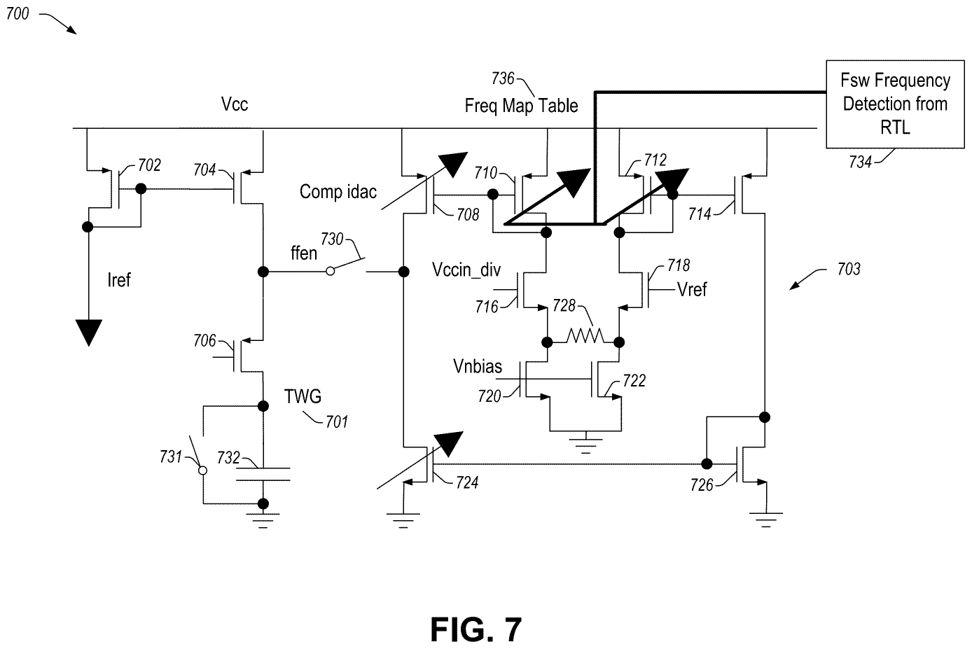

FIG. 7 is a block diagram of a voltage regulator 700 with an input voltage feedforward path to a triangle wave generator (TWG), in accordance with some embodiments. Referring to FIG. 7, VR 700 includes transistors 702, 704, and 706, a TWG 701 (including a switch 731 coupled to a capacitor 732), a switch 730, and an amplifier 703.

In some aspects, amplifier 703 includes transistors 708, 710, 712, 714, 716, 718, 720, 722, 724, and 726. Amplifier 703 also includes a degenerating resistor 728 coupled between differential pair source terminals (as illustrated in FIG. 7). In some aspects, amplifier 703 uses frequency detection circuit 734 to supply a frequency mapping table 736, which can be used for tuning the amplifier 703.

In some aspects, VR 700 is configured with the OTA current added to the integrating current for TWG. As discussed earlier, the FIVR primary integrating current is a slow generation path and may not be suitable for adding the Vin dependency directly. The configuration of VR 700 solves this issue by summing the primary current and the OTA current. As the primary current is proportional to switching frequencies, the added OTA current can be adjusted to frequencies accordingly to maintain a fixed compensation current ratio across frequencies.

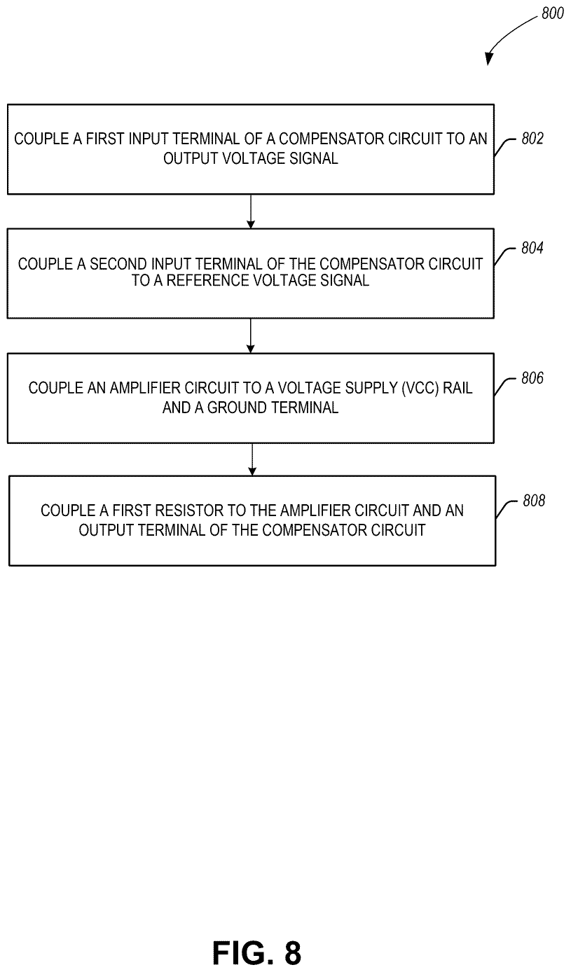

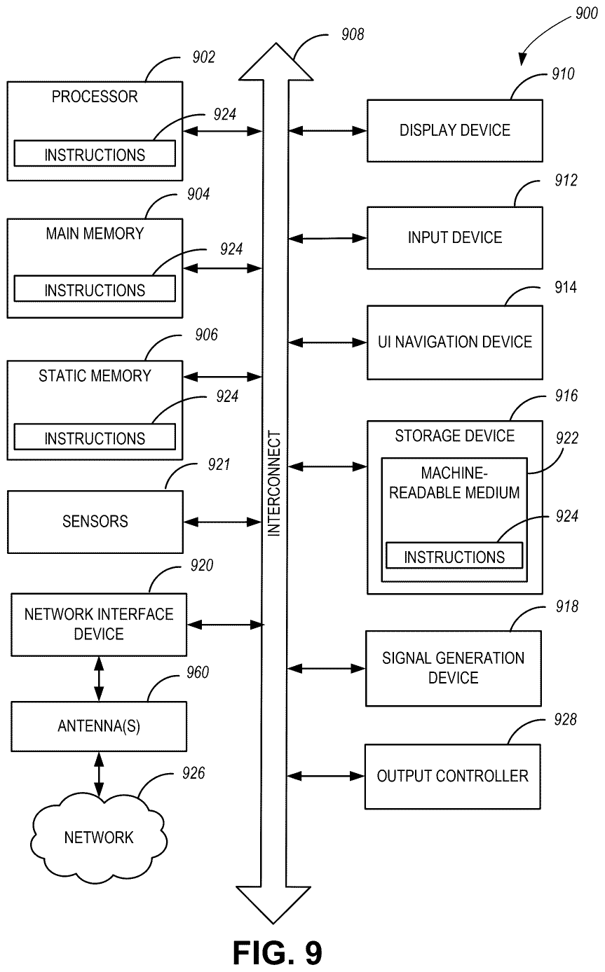

FIG. 8 is a flow diagram of an example process of making a voltage regulator, in accordance with some embodiments. Referring to FIG. 8, process 800 includes operations 902, 904, 906, and 908, which may be executed by a processor, an embedded controller, a receiver circuit, a transceiver circuit, or another processor of a computing device (e.g., hardware processor 902 of machine 900 illustrated in FIG. 9, which can include one or more of the circuits discussed in connection with FIGS. 1-7). In some embodiments, one or more of the circuits described in connection with FIGS. 1-7 can perform the functionalities (or include the configurations or circuitry) associated with FIG. 8, as well as one or more of the examples listed below.

At operation 802, a first input terminal of a compensator circuit (e.g., compensator circuit 320 in FIG. 3) to an output voltage signal (e.g., Vout).

At operation 804, a second input terminal of the compensator circuit is coupled to a reference voltage signal (e.g., Vcpsref).

At operation 806, an amplifier circuit (e.g., amplifier 307) is coupled to a voltage supply (Vcc) rail and a ground terminal.

At operation 808, a first resistor (e.g., resistor 322) is coupled to the amplifier circuit and an output terminal of the compensator circuit.

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, machine 900 may operate in the capacity of a server machine, a client machine, or both in server-client network environments. In an example, machine 900 may function as a peer machine in a peer-to-peer (P2P) (or other distributed) network environment. The machine 900 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 900 may include a hardware processor 902 (e.g., a central processing unit (CPU), a graphics processing unit (GPU), a hardware processor core, or any combination thereof), a main memory 904, and a static memory 906, some or all of which may communicate with each other via an interlink (e.g., bus) 908. In some aspects, the main memory 904, the static memory 906, or any other type of memory (including cache memory) used by machine 900 can be configured based on the disclosed techniques or can implement the disclosed memory devices.

Specific examples of main memory 904 include Random Access Memory (RAM) and semiconductor memory devices, which may include, in some embodiments, storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 900 may further include a display device 910, an input device 912 (e.g., a keyboard), and a user interface (UI) navigation device 914 (e.g., a mouse). In an example, the display device 910, the input device 912, and the UI navigation device 914 may be a touchscreen display. The machine 900 may additionally include a storage device (e.g., drive unit or another mass storage device) 916, a signal generation device 918 (e.g., a speaker), a network interface device 920, and one or more sensors 921, such as a global positioning system (GPS) sensor, compass, accelerometer, or other sensors. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 902 and/or instructions 924 may comprise processing circuitry and/or transceiver circuitry.

The storage device 916 may include a machine-readable medium 922 on which one or more sets of data structures or instructions 924 (e.g., software) embodying or utilized by any one or more of the techniques or functions described herein can be stored. Instructions 924 may also reside, completely or at least partially, within the main memory 904, within static memory 906, or the hardware processor 902 during execution thereof by machine 900. In an example, one or any combination of the hardware processor 902, the main memory 904, the static memory 906, or the storage device 916 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 922 is illustrated as a single medium, the term “machine-readable medium” may include a single medium or multiple media (e.g., a centralized or distributed database and/or associated caches and servers) configured to store instructions 924.

An apparatus of machine 900 may be one or more of a hardware processor 902 (e.g., a central processing unit (CPU), a graphics processing unit (GPU), a hardware processor core, or any combination thereof), a main memory 904 and a static memory 906, one or more sensors 921, a network interface device 920, one or more antennas 960, a display device 910, an input device 912, a UI navigation device 914, a storage device 916, instructions 924, a signal generation device 918, and an output controller 928. The apparatus may be configured to perform one or more of the methods and/or operations disclosed herein. The apparatus may be intended as a component of machine 900 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 900 and that causes machine 900 to perform any one or more of the techniques of the present disclosure, or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 924 may further be transmitted or received over a communications network 926 using a transmission medium via the network interface device 920 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.8.4 family of standards, a Long Term Evolution (LTE) family of standards, a Universal Mobile Telecommunications System (UMTS) family of standards, peer-to-peer (P2P) networks, among others.

In an example, the network interface device 920 may include one or more physical jacks (e.g., Ethernet, coaxial, or phone jacks) or one or more antennas to connect to the communications network 926. In an example, the network interface device 920 may include one or more antennas 960 to wirelessly communicate using at least one single-input multiple-output (SIMO), multiple-input multiple-output (MIMO), or multiple-input single-output (MISO) techniques. In some examples, the network interface device 920 may wirelessly communicate using multiple-user MIMO techniques. The term “transmission medium” shall be taken to include any intangible medium that can store, encode, or carry instructions for execution by machine 900 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented wholly or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.

Example 1 is an apparatus comprising: a compensator circuit comprising a first input terminal coupled to an output voltage signal and a second terminal coupled to a reference voltage signal; an amplifier circuit coupled to a voltage supply (Vcc) rail and a ground terminal; and a first resistor coupled to the amplifier circuit and an output terminal of the compensator circuit.

In Example 2, the subject matter of Example 1 includes a first impedance circuit coupled to the first input terminal of the compensator circuit; and a second impedance circuit coupled to the first input terminal and the output terminal of the compensator circuit.

In Example 3, the subject matter of Examples 1-2 includes a comparator circuit comprising a first input terminal coupled to a triangle wave generator (TWG) signal and a second terminal coupled to an output terminal of the amplifier circuit.

In Example 4, the subject matter of Example 3 includes an inverter circuit coupled to an output terminal of the comparator circuit; a driver circuit coupled to an output terminal of the inverter circuit; a pair of switch transistors coupled to output terminals of the driver circuit; and an inductance coupled to the pair of switched transistors.

In Example 5, the subject matter of Example 4 includes subject matter where the inductance is coupled to the first input terminal of the compensator circuit via an impedance circuit.

In Example 6, the subject matter of Examples 1-5 includes subject matter where the amplifier circuit comprises: a first transistor comprising a source terminal coupled to the Vcc rail and a drain terminal coupled to the first resistor; and a second transistor comprising a drain terminal coupled to the drain terminal of the first transistor and a source terminal coupled to the ground terminal.

In Example 7, the subject matter of Example 6 includes subject matter where the amplifier circuit comprises: a third transistor comprising a source terminal coupled to the Vcc rail and a drain terminal coupled to the first resistor; and a fourth transistor comprising a drain terminal coupled to the drain terminal of the third transistor and a source terminal coupled to the ground terminal.

In Example 8, the subject matter of Example 7 includes subject matter where the amplifier circuit comprises: a fifth transistor comprising a gate terminal coupled to a gate terminal of the first transistor; a sixth transistor comprising a drain terminal coupled to a drain terminal of the fifth transistor; and a seventh transistor comprising a drain terminal coupled to a source terminal of the sixth transistor and a source terminal coupled to the ground terminal.

In Example 9, the subject matter of Example 8 includes subject matter where the amplifier circuit comprises: an eighth transistor comprising a gate terminal coupled to a gate terminal of the third transistor; a ninth transistor comprising a drain terminal coupled to a drain terminal of the eighth transistor; and a tenth transistor comprising a drain terminal coupled to a source terminal of the ninth transistor and a source terminal coupled to the ground terminal.

In Example 10, the subject matter of Example 9 includes subject matter where the amplifier circuit comprises: a second resistor coupled between the source terminal of the ninth transistor and the source terminal of the sixth transistor.

In Example 11, the subject matter of Example 10 includes subject matter where the amplifier circuit comprises: a capacitor coupled to an output terminal of the amplifier circuit and the first resistor.

In Example 12, the subject matter of Examples 10-11 includes a system-on-chip (SoC), the SoC comprising an integrated circuit (IC), the IC comprising at least one of the compensator circuit, the amplifier circuit, the first resistor, or the second resistor.

In Example 13, the subject matter of Example 12 includes subject matter where the SoC further comprises at least one connector, and wherein the at least one connector conforms with at least one of a Universal Serial Bus (USB) specification, a High-Definition Multimedia Interface (HDMI) specification, a Thunderbolt specification, a Peripheral Component Interconnect Express (PCIe) specification, or an Ethernet specification.

Example 14 is an apparatus comprising: an amplifier comprising: a first differential pair of transistors comprising a first pair of source terminals coupled to a voltage supply (Vcc) rail; a second differential pair of transistors comprising a second pair of source terminals; and a first resistor coupled between the second pair of source terminals; a second resistor coupled to an output of the amplifier; and a compensator circuit comprising an output terminal coupled to the second resistor, the compensator circuit is to generate a compensator output voltage signal based on a first reference voltage signal.

In Example 15, the subject matter of Example 14 includes subject matter where a first gate terminal of the second differential pair of transistors receives an input voltage signal, and wherein a second gate terminal of the second differential pair of transistors receives a second reference voltage signal.

In Example 16, the subject matter of Example 15 includes subject matter where the compensator circuit is to generate the compensator output voltage signal further based on the input voltage signal.

In Example 17, the subject matter of Examples 14-16 includes subject matter where a first gate terminal of the first differential pair of transistors is coupled to a first tuning transistor, and wherein a second gate terminal of the first differential pair of transistors is coupled to a second tuning transistor.

In Example 18, the subject matter of Examples 14-17 includes a first impedance circuit coupled to a first input terminal of the compensator circuit; and a second impedance circuit coupled to a second input terminal of the compensator circuit.

Example 19 is a process of making a voltage regulator, the process comprising: coupling a first input terminal of a compensator circuit to an output voltage signal; coupling a second input terminal of the compensator circuit to a reference voltage signal; coupling an amplifier circuit to a voltage supply (Vcc) rail and a ground terminal; and coupling a first resistor to the amplifier circuit and an output terminal of the compensator circuit.

In Example 20, the subject matter of Example 19 includes coupling a first impedance circuit to the first input terminal of the compensator circuit; coupling a second impedance circuit to the first input terminal and the output terminal of the compensator circuit; and coupling a second resistor between source terminals of differential pair transistors of the amplifier.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a compensator circuit comprising a first input terminal coupled to an output voltage signal and a second terminal coupled to a reference voltage signal;
an amplifier circuit coupled to a voltage supply (Vcc) rail and a ground terminal; and
a first resistor coupled to the amplifier circuit and an output terminal of the compensator circuit.

2. The apparatus of claim 1, further comprising:
a first impedance circuit coupled to the first input terminal of the compensator circuit; and
a second impedance circuit coupled to the first input terminal and the output terminal of the compensator circuit.

3. The apparatus of claim 1, further comprising:
a comparator circuit comprising a first input terminal coupled to a triangle wave generator (TWG) signal and a second terminal coupled to an output terminal of the amplifier circuit.

4. The apparatus of claim 3, further comprising:
an inverter circuit coupled to an output terminal of the comparator circuit;
a driver circuit coupled to an output terminal of the inverter circuit;
a pair of switch transistors coupled to output terminals of the driver circuit; and
an inductance coupled to the pair of switched transistors.

5. The apparatus of claim 4, wherein the inductance is coupled to the first input terminal of the compensator circuit via an impedance circuit.

6. The apparatus of claim 1, wherein the amplifier circuit comprises:
a first transistor comprising a source terminal coupled to the Vcc rail and a drain terminal coupled to the first resistor; and
a second transistor comprising a drain terminal coupled to the drain terminal of the first transistor and a source terminal coupled to the ground terminal.

7. The apparatus of claim 6, wherein the amplifier circuit comprises:
a third transistor comprising a source terminal coupled to the Vcc rail and a drain terminal coupled to the first resistor; and
a fourth transistor comprising a drain terminal coupled to the drain terminal of the third transistor and a source terminal coupled to the ground terminal.

8. The apparatus of claim 7, wherein the amplifier circuit comprises:
a fifth transistor comprising a gate terminal coupled to a gate terminal of the first transistor;
a sixth transistor comprising a drain terminal coupled to a drain terminal of the fifth transistor; and
a seventh transistor comprising a drain terminal coupled to a source terminal of the sixth transistor and a source terminal coupled to the ground terminal.

9. The apparatus of claim 8, wherein the amplifier circuit comprises:
an eighth transistor comprising a gate terminal coupled to a gate terminal of the third transistor;
a ninth transistor comprising a drain terminal coupled to a drain terminal of the eighth transistor; and
a tenth transistor comprising a drain terminal coupled to a source terminal of the ninth transistor and a source terminal coupled to the ground terminal.

10. The apparatus of claim 9, wherein the amplifier circuit comprises:
a second resistor coupled between the source terminal of the ninth transistor and the source terminal of the sixth transistor.

11. The apparatus of claim 10, wherein the amplifier circuit comprises:
a capacitor coupled to an output terminal of the amplifier circuit and the first resistor.

12. The apparatus of claim 10, comprising:
a system-on-chip (SoC), the SoC comprising an integrated circuit (IC), the IC comprising at least one of the compensator circuit, the amplifier circuit, the first resistor, or the second resistor.

13. The apparatus of claim 12, wherein the SoC further comprises at least one connector, and wherein the at least one connector conforms with at least one of a Universal Serial Bus (USB) specification, a High-Definition Multimedia Interface (HDMI) specification, a Thunderbolt specification, a Peripheral Component Interconnect Express (PCIe) specification, or an Ethernet specification.

14. An apparatus comprising:
an amplifier comprising:
a first differential pair of transistors comprising a first pair of source terminals coupled to a voltage supply (Vcc) rail;
a second differential pair of transistors comprising a second pair of source terminals; and
a first resistor coupled between the second pair of source terminals;
a second resistor coupled to an output of the amplifier; and
a compensator circuit comprising an output terminal coupled to the second resistor, the compensator circuit is to generate a compensator output voltage signal based on a first reference voltage signal.

15. The apparatus of claim 14, wherein a first gate terminal of the second differential pair of transistors receives an input voltage signal, and wherein a second gate terminal of the second differential pair of transistors receives a second reference voltage signal.

16. The apparatus of claim 15, wherein the compensator circuit is to generate the compensator output voltage signal further based on the input voltage signal.

17. The apparatus of claim 14, wherein a first gate terminal of the first differential pair of transistors is coupled to a first tuning transistor, and wherein a second gate terminal of the first differential pair of transistors is coupled to a second tuning transistor.

18. The apparatus of claim 14, comprising:
a first impedance circuit coupled to a first input terminal of the compensator circuit; and
a second impedance circuit coupled to a second input terminal of the compensator circuit.

19. A process of making a voltage regulator, the process comprising:
coupling a first input terminal of a compensator circuit to an output voltage signal;
coupling a second input terminal of the compensator circuit to a reference voltage signal;
coupling an amplifier circuit to a voltage supply (Vcc) rail and a ground terminal; and
coupling a first resistor to the amplifier circuit and an output terminal of the compensator circuit.

20. The process of claim 19, further comprising:
coupling a first impedance circuit to the first input terminal of the compensator circuit;
coupling a second impedance circuit to the first input terminal and the output terminal of the compensator circuit; and
coupling a second resistor between source terminals of differential pair transistors of the amplifier.
